(19) United States
(12) Patent Application Publication
(10) Pub. No.: US 2013/0311256 A1
(43) Pub. Date: Nov. 21, 2013

(54) METHOD FOR PROVIDING MARKETING AND INCENTIVES FOR CUSTOMERS AND/OR BUSINESSES

(71) Applicant: Shawn G. Inks, Richfield, OH (US)

(72) Inventor: Shawn G. Inks, Richfield, OH (US)

(73) Assignee: ITI GROUP, LLC, Broadview Heights, OH (US)

(21) Appl. No.: 13/473,056

(22) Filed: May 16, 2012

(51) Int. Cl. G06Q 30/02

(52) U.S. Cl. 705/14.15

(57) ABSTRACT

A platform connects customers and businesses for purchasing goods and/or services at a first price, which is less than a second price offered to the general public. Offers are made to customers through the platform under a first payment option or a second payment option. The first payment option is a pay now option where a customer pays for the voucher before receiving it, and the business pays financial consideration to the platform for the opportunity to provide the vouchers. The second payment option is a pay later option where the business pays no financial consideration to the platform for its offers. Customers pay a periodic subscription and receive the vouchers without payment. Payment for the vouchers occurs directly with the business at the time of redemption. Businesses may also be paid commissions for attracting customers to use the platform.

### I. BACKGROUND OF THE INVENTION

A. Field of Invention

The present application is directed to novel methods for providing incentives for customers and/or businesses. More specifically, the instant invention is directed to novel methods for providing incentives for customers and/or businesses on a group purchasing platform on a global computer network.

B. Description of the Related Art

Group purchasing websites, such as Groupon® and Living Social®, serve as a platform to bring together businesses and customers. The business' goal is to sell more products and services and increase their customer base. Customers are looking for discounted prices at favorite establishments or new places.

The platform provides which businesses offer discounted products and services, and communicates these discounted products and services to the customers. Currently, these group purchasing websites require that the discounted products and services to be purchased on their websites in the form of a voucher or similar instrument. Since the voucher is purchased prior to the actual receipt of the products and services, there is a chance that the voucher may not be used. Some reasons why the voucher goes unused may include: 1) the store has gone out of business or is closed, 2) the voucher is lost, and/or 3) the customer does not like the goods and/or services of the business after viewing or experiencing them or reading negative reviews.

Another shortfall for these websites is that they may provide businesses a means to showcase their products and services, but at a deeply discounted rate that may hurt the business. More specifically, once a business posts a voucher for discounted products or services, a percentage of the price for the vouchers purchased must be given to the group purchasing website, diminishing the revenue for the business. The value of the voucher now received by the business may be so low that the business is losing money on the products or services. The business may also lose money when a single voucher is used multiple times, further decreasing the revenue for the business. Although the business may rely on repeat customers from the voucher program, customers may not choose to purchase future goods and/or services from the business without the discount given in the voucher. If customers do not return to the business, the business is ultimately hurt by its attempt to gain exposure through the group purchasing website. As such, a business may be hesitant to use a group purchasing site for their discounted products or services unless other income incentives are available. Customers may also be more likely to use a group purchasing site if incentives are also available to them.

As such, there is a need in the art for a group purchasing website that allows a customer to decide whether or not to use a voucher for a discounted price on a product or service. The present invention provides methods to allow customers to decide when to purchase the products and services with their vouchers.

Additionally, there is also a need to provide incentives to businesses and/or customers to not only utilize the group purchasing site but also receive revenue from the site. The present invention also enables both customers and business to create this additional revenue by providing business and/or customer referrals to the group purchasing site.

### II. SUMMARY OF THE INVENTION

According to one aspect of the present invention, a new and improved method for marketing to customers and businesses may comprise the steps of providing a platform on a global computer network for buying and selling of a good and/or service, providing a business, wherein the business selectively offers the good and/or service at a first price, wherein the good and/or service are available for sale outside of the platform at a second price, wherein the first price is less than the second price; providing an account with the platform to a customer, wherein the customer desires to receive the good and/or service from the business at the first price; and offering the customer a first payment option and a second payment option for purchasing the good and/or service at the first price; receiving the customer's selection of the first payment option or the second payment option; and sending the customer a voucher.

Another object of the present invention is to provide a method for marketing to customers and businesses wherein the first payment option further comprises the steps of: paying a subscription fee during a repeating time period; redeeming the voucher via the business; and paying for the good and/or service at the first price.

Further, another object of the present invention is to provide a method for marketing to customers and businesses, wherein the business does not pay financial consideration to the platform for offering the good and/or service at the first price.

Still yet, another object of the present invention is to provide a method for marketing to customers and businesses wherein the second payment option further comprises the step of paying for the good and/or service at the first price via the platform before receiving the voucher.

Yet, another object of the present invention is to provide a method for marketing to customers and businesses wherein the business pays financial consideration to the platform for offering the good and/or service at the first price.

Still, another object of the present invention is to provide a method for marketing to customers and businesses wherein the option of when to purchase the good and/or service at the first price requires a subscription.

Another object of the present invention is to provide a method for marketing to customers and businesses wherein the cost of the purchase of the good and/or service at the first price varies by when the purchase is made.

Further, another object of the present invention is to provide a method for marketing to customers and businesses in which the business is a generic business type.

Still yet, another object of the present invention is to provide a method for marketing to customers and businesses wherein a specific business has an operating address.

Yet, another object of the present invention is to provide a method of providing incentives for customers and businesses, comprising the steps of providing a platform on a global computer network for buying and selling of a good and/or service by a user; allowing a user to refer a new client; and providing commission to a user for buying and selling by a new client.

Another object of the present invention is to provide a method for marketing to customers and businesses wherein the user is provided from at least one user of a business, a customer, a direct sales consultant, an independent representative, and a viral consumer.

Further, another object of the present invention is a method of providing incentives for customers and businesses wherein the new client is a business.

Another object of the present invention is a method of providing incentives for customers and businesses wherein the new client is a customer.

Another object of the present invention is to provide a method for marketing to customers, comprising of steps of: providing a platform on a global computer network for buying and selling of a good and/or service; providing a business, the business selectively offering the good and/or service at a first price, wherein the good and/or service are available for sale outside of the platform at a second price, wherein the first price is less than the second price; providing an account with the platform to a customer, the customer paying a subscription fee during a repeating time period; offering the customer the good and/or service at the first price; sending the customer a voucher; and redeeming the voucher with the business, wherein the customer pays the first price when the voucher is redeemed with the business.

Another object of the present invention is to provide a method for marketing to customers, wherein the business does not pay financial consideration to the platform for offering the good and/or service at the first price.

Another object of the present invention is provide a method for marketing to customers, wherein the customer subscription fee is reduced when the customer refers a second customer to the platform.

Further, another object of the present invention is to provide a method for marketing to customers, wherein the customer subscription fee is zero when the customer refers a plurality of customers to the platform.

Still yet, another object of the present invention is to provide a method for marketing to customers, wherein the customer subscription fee is reduced when the customer refers a second customer to the platform and the second customer pays its own subscription fee.

Still, another object of the present invention is to provide a method for marketing to customers, wherein the business pays financial consideration to the website for offering the good and/or service but does not pay additional financial consideration on a per transaction basis.

Still, another object of the present invention is to provide a method for marketing to customers, wherein the business does not pay financial consideration to the platform on a per transaction basis.

Yet, another object of the present invention is to further provide a method for providing incentives for customers and businesses wherein the method further comprises the steps of allowing the new client to refer another client and providing the commission to both the user and the new client.

Further, another object of the present invention is to provide a method for providing incentives for customers and businesses wherein the commission is provided to a plurality of users and new client(s) for referring another client.

Still yet another object of the present invention is to method for marketing to both customers and businesses, comprising the steps of providing a platform on a global computer network for buying and selling of a good and/or service; providing a business, wherein business selectively offers the good and/or service at a first price, wherein the good and/or service are available for sale outside of the platform at a second price, wherein the first price is less than the second price; providing a customer having an account with a platform, where a customer desires to receive a good and/or service from a business at a first price; providing a customer an option of when to purchase a good and/or service at a first price wherein the option requires a subscription; receiving a voucher for a good and/or service from a platform at first price; redeeming the voucher for a good and/or service wherein a purchase occurs through a platform or a business; allowing a business or a customer to refer a new client; and providing commission to a business or a customer for buying and selling by a new client, wherein a commission is provided to at least one of a business and a customer for referring another client.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 is a flow chart showing the present invention.

FIG. 2 is a flow chart illustrating another aspect of the present invention.

FIG. 3A is a flow chart showing another aspect of the present invention.

FIG. 3B is a flow chart showing another aspect of the present invention.

### IV. DETAILED DESCRIPTION OF THE INVENTION

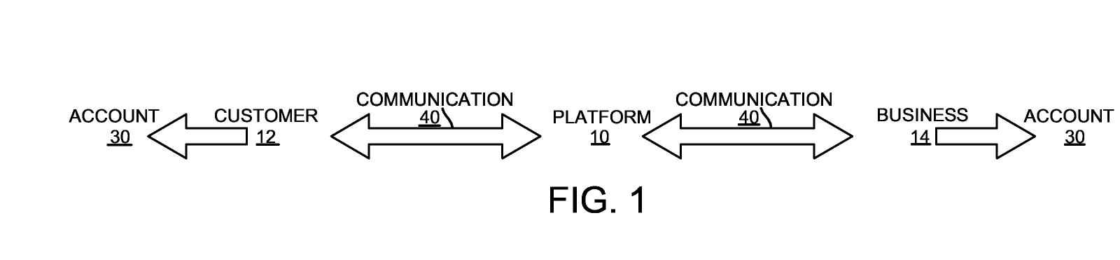

Referring now to the drawings wherein the showings are for purposes of illustrating embodiments of the invention only and not for purposes of limiting the same, FIGS. 1, 2, 3A, and 3B illustrate the present invention. The present invention may provide customers with the different payment options for purchasing vouchers through group purchasing websites. The present invention may also provide incentives with respect to commerce carried out through a global computer network such as the internet. These incentives may encourage both customers and businesses to promote group purchasing websites to future customers and businesses.

With specific reference to FIG. 1, the general overview of group purchasing websites is shown. A customer 12 or plurality of customers 15 can receive information and vouchers from a business 14 or plurality of businesses 20 through a platform 10.

The single customer 12 may be a person who purchases good(s) and/or service(s) at a store with a physical location, over a mobile phone or landline phone, by mail, over the internet, and/or by some other means. The business 14 may be a generic business type such as dry cleaning services. The business 14 may also be a specific business having an operating address such as Mike's Dry Cleaning on South Main Street in Anytown, Ohio. The business 14 may also have a physical location. A business 14 may engage in electronic commerce by the conduct sales through a global computer network.

With a group purchasing website, business 14 may have increased exposure to old and new customers 12 on a regular systematic basis. The business 14 may also have the opportunity to showcase some good(s) and/or service(s).

The platform 10 serves as the intermediary between plurality of customers 15 and a plurality of businesses 20. Customers 12 and businesses 14 can buy and sell good(s) and/or service(s) through the platform 10 on a global computer network such as the internet. One non-limiting example of such platform is described in a utility patent application having Ser. No. 13/325,830, which is incorporated herein by reference. Communications 40 transmitted from the customer 12 to the business 14 or from the business 14 to the customer 12 may be sent through the platform 10. Any customer 12, business 14, person or entity utilizing the platform 10 may create an account 30 with the platform 10. Communications 40 may take any form including without limitation, newsletters, messaging, vouchers, advertisements, business updates or activity, and/or any other information. Communications 40 may be sent through any medium including without limitation email, SMS messaging, computer programs or mobile applications, and/or another means. Communications 40 may be sent via the platform 10 as frequently as desired. The timing for receiving any communications 40 may be selected by the platform 10 and/or the business 14.

The business 14 selectively offers the good(s) and/or service(s) at a first price through the platform 10. The first price is different from a second price. The second price is available to the general public. Generally the first price is less than the second price. Besides a reduced dollar amount, the first price may also be a flat discount or a percentage off the second price. The customer 12 desires to receive the good(s) and/or service(s) from the business 14 at the first price and takes action to purchase the good(s) and/or service(s) at the first price. This purchase of the good(s) and/or service(s) may also be referred to as “claiming” or “reserving” a discount. Upon receipt of the customer's purchase, a business 14 then sends communication via the platform 10 to the customer 12 for the good(s) and/or service(s) at the first price in the form of a voucher.

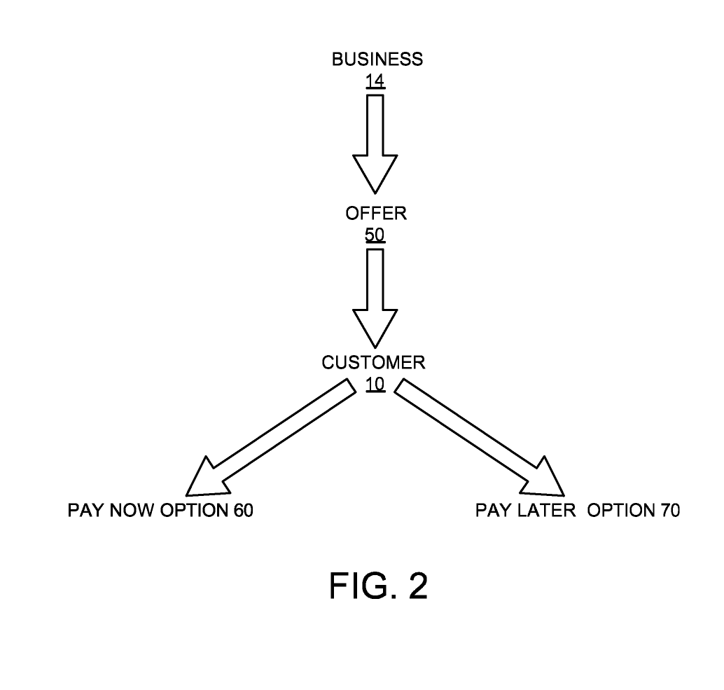

With reference to FIG. 2, the business 14 provides an offer 50 to a customer 12 through the platform 10. The offer 50 may be provided through the group purchasing website. The offer 50 by the business 14 may be for at least one good and/or service. Also, a plurality of businesses may provide a combined offer 50, which may present a plurality of goods and/or services in the offer 50. For the offer 50, the customer 12 may choose from a first payment option 60 or a second payment option 70. The first payment option may be referenced to as a pay now option 60.

With the pay now option 60, the customer 12 purchases, meaning renders payment for, the voucher through the platform 10 prior to receiving the good(s) and/or services. With the pay later option 70, the customer 12 can receive the voucher through the platform 10 prior to purchasing the good(s) and/or service(s).

For the pay now option 60, a customer 12 finds the offer 50 from the business 14 through the platform 10. The offer 50 includes the good(s) and/or service(s) that may be available at a first price, wherein the price offered through the platform 10 is less that the second price offered outside of the platform 10. The customer 12 then pays for the good(s) and/or service(s) at the first price. After purchasing the voucher through the platform 10 of the group purchasing website at the lower first price, the voucher may then be received by digital transmission. The customer 12 may then redeem the voucher for the offer 50. When the voucher is redeemed by the customer 12, no additional money is paid to the business 14 for the good(s) and/or service(s) from the offer 50 since the customer 12 previously paid for the voucher through the platform 10.

The voucher using the pay now option 60 may be redeemed at a store, by internet, by phone, by catalog, or by any other means in which an offer 50 may be redeemed. Customers 10 may redeem their vouchers electronically, for example through a mobile device or a computer. Alternatively, customers 10 may redeem vouchers by presenting a hard copy of the voucher to the business 14 at the time of redemption. Still further, the unique voucher can provide a redemption code used online to place an order on a separate business website. Regardless of mode of redemption, the voucher is verified through the platform 10. If is confirmed to be a valid voucher, the redemption may occur and the database may be updated accordingly on the platform 10 to reflect the redeemed status.

For the first option, the pay now option 60, the business 14 may be required to pay financial consideration to the owner of the platform for providing the offer 50 for its good(s) and/or service(s). Financial consideration may be a flat fee or it may be based on a percentage of sales made for the vouchers for a given offer 50. In the first payment option, this financial consideration can now reduce any profits for the business 14 since the flat fee or percentage of sales may be subtracted from the price of the offer 50.

By way of a non-limiting example, the first payment option 60 is now further explained. The customer 12 receives an offer 50 for its favorite restaurant. The restaurant offers a $20 food voucher for the first price of $10. The customer 12 pays $10 through the platform. Upon confirmation of payment, the voucher is sent electronically to the customer 12. Providing the customer 12 meets the timing requirements applicable to the voucher, the customer 12 redeems the voucher at the business 14, thus receiving the $20 value while only paying $10 at the time of purchase. Of course, the customer 12 faces the risk of not meeting the time deadlines set forth on the voucher or simply changing their mind. For those time deadlines, either the discount may diminish over time or the voucher may only be redeemed for the price paid.

For the second payment option, also referred to as the pay later option 70, the customer 12 finds or received the offer 50 from the business 14 through the platform 10. The offer 50 is the good(s) and/or service(s) that may be available at a certain price, wherein the price offered through the platform 10 is less than the second price, when offered outside of the platform 10. To utilize the second payment option 70, the customer 12 pays a subscription fee for the platform in exchange for delaying payment for the voucher and accessing the offers 50 within the pay later option 70. The customer 12 may only be able to view offers 50 from the pay later option 70 after paying the subscription fee. The customer 12 may pay the subscription fee during a repeating time period, such as monthly, quarterly, or annually, or a time period in order to have access to the pay later option 70. Additionally, the customer 12 may be able to receive an unlimited amount of vouchers from the offers 50 advertised. Businesses 14 may be required to pay financial consideration in the form of a subscription fee to the platform 10 for offers 50 provided under the second payment option 70. The subscription fees for the businesses 14 may be based on the level of integration within the platform 10, any packages offered by the platform 10, and/or services needed from the platform 10. These services may include printed marketing material and technical support. In this pay later option 70, business would not pay financial consideration on a per transaction basis with the customer 12. With subscription fees from both the customer 12 and the business 14, the platform 10 may then be able to provide income in addition to the fees acquired by the customer subscriptions. Further, subscription fees paid by businesses 14 or customers 12 may be decreased, even to zero, by referring new businesses 14 and customers 12 to the platform 10

The customer 12 obtains the voucher for the good(s) and/or service(s) through the platform 10 of the group purchasing website at the lower price. Without paying for the purchase price of the voucher at the time of acquisition, customers 10 may obtain the vouchers electronically, for example through a mobile device or a computer. Alternatively, customers 10 may redeem vouchers by obtaining a hard copy through the platform 10. Still further, the voucher can provide a redemption code that may be used to place an order on a separate business website. Regardless of mode of redemption, the voucher can be verified through the platform 10. If it is confirmed to be a valid voucher, the redemption may occur and the database may be updated accordingly to reflect the redeemed status.

After receiving the voucher through the platform 10 for the pay later option 70, the good(s) and/or service(s) may be purchased from the business 14 at the first price. The good(s) and/or service(s) from the business 14 may be received at a physical location of the business 14. The good(s) and/or service(s) from the business 14 may also be received though a website, catalog, by phone, or another means. At the time when the good(s) and/or service(s) obtained through the voucher are received by the customer 12 from the business 14 payment of the good(s) and/or service(s) may then be rendered, resulting in the full value of the first price being paid to the business 14.

The customer 12 using the pay later option 70 has the option to not redeem the voucher for the good(s) and/or service(s). For example, the customer 12 may choose not to redeem the voucher due to dissatisfaction of good(s) and/or services without incurring financial loss. In other situations, by using the pay later option 70, the customer 12 may prevent the possibility of wasting money on unused vouchers. For instance, the customer 12 may lose the voucher or forget to redeem the voucher. Also, a customer may not be able to redeem the voucher if the business 14 no longer exists.

By means of non-limiting example, the second payment option, the pay later option 70, will be further explained. The customer 12 pays a monthly subscription fee of $10 to the platform 10. Upon receiving an offer 50 from the customer's favorite restaurant under the pay later option 70, the customer 12 decides to accept/claim/reserve the offer 50. The $20 food voucher is available for $10 as set forth in the previous example. However, because the customer 12 pays the monthly subscription fee, the customer 12 receives the voucher without rendering payment. Further, the business 14 does not provide payment to the platform 10, but may be required to pay a monthly subscription fee to provide the pay later option 70. After a certain time period lapses, for example two weeks, the customer 12 with its received but unredeemed voucher patronizes the restaurant. Upon receiving the food bill, the customer 12 then pays the $10 for the voucher but receives $20 worth of food.

Additionally, customers 12 may also have the options of using both the pay now option 60 and the pay later option 70. To have the option of using both the pay now option 60 and pay later option 70, the customer 12 may need to pay the subscription fee. Although the first price offered through the platform 10 is less than the second price offered outside of the platform 10, the first price for the offer 50 may be the same for the pay now option 60 and the pay later option 70. Alternatively, the first price for the offer 50 may be different for the pay now option 60 and the pay later option 70.

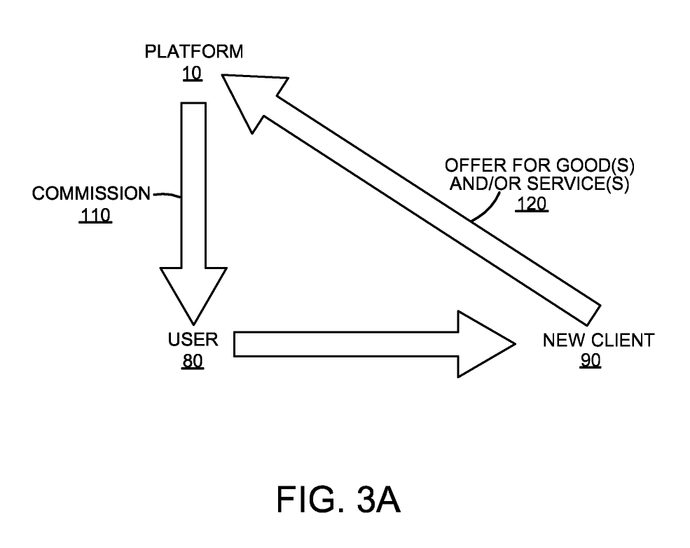

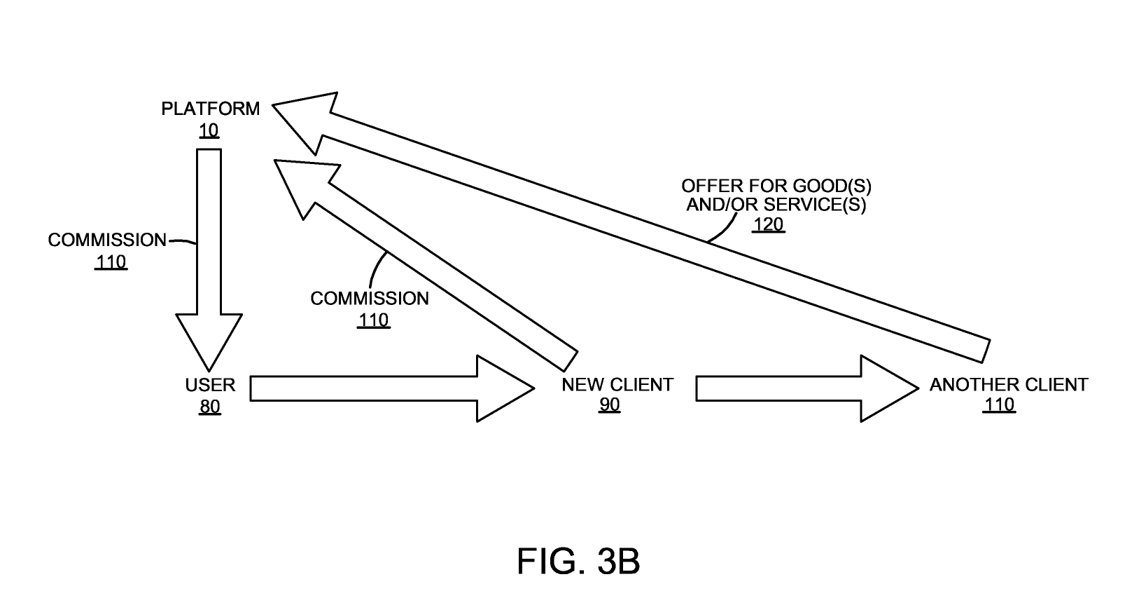

With respect to FIGS. 3A and 3B, incentives may be provided to users 80 bringing in added business to the group purchasing website. A user 80 may be the business 14, the customer 12, a direct sales consultant, an independent representative, and/or a viral consumer. These incentives may include commission 110. The commission 110 provided to user 80 may be a flat fee, a percentage of the price paid for the good(s) and/or service(s) sold by the new client 90, a credit to the group purchasing website, a waiver of fees to the group purchasing website, discounted services to the group purchasing website, and/or some other incentive given to user 80.

In FIG. 3A, the user 80 refers a new client 90 to the global computer network for buying and/or selling of good(s) and/or service(s). The new client 90 may be the business 14 or the customer 12 desiring to provide an offer for good(s) and/or services 120. After the new client 90 provides an offer for good(s) and/or services(s) 120 through the platform 10, the commission 110 may be provided to the user 80 for the referral of the new client 90. The offer for good(s) and/or service(s) 120 may also be at a first price where the first price is different from the second price which is available to the general public. Generally the first price is less than the second price. Also, user 80 and the new client 90 may provide a combined offer, which may present a plurality of goods and/or services in the offer for good(s) and/or service(s) 120.

After the offer for good(s) and/or service(s) 120 can be provided to the platform 10, sales from the offer for good(s) and/or service(s) 120 may begin. Based on these sales, the platform 10 from the global computer network can provide the commission 110. The commission 110 may be paid to the user 80 as shown in FIG. 3A.

With FIG. 3B, additional commission 110 may be provided to not only the user 80 but also the new client 90. If a new client 90 is able to refer another client 100 in order to bring in business for the group purchasing site on the global computer network, then both the user 80 and the new client 90 may be eligible for commission 110. Another client 100 may be the business 14 or the customer 12 desiring to provide an offer for good(s) and/or services 120. When another client 100 provides an offer for good(s) and/or service(s) 120 to the platform 10, sales from the offer for good(s) and/or service(s) 120 may begin. Based on these sales, the platform 10 from the global computer network can provide a commission 110. The commission 110 may be paid to both user 80 and new client 90.

Also, user 80, new client 90, and/or another client 100 may provide a combined offer, which may present a plurality of goods and/or services in the offer for good(s) and/or service(s) 120.

The process shown in FIG. 3B may also be repeated to provide commissions 110 to another client 100 after another client 100 provides a referral to list an offer for good(s) and/or service(s) 120 through platform 10.

It is contemplated to be within the scope of the invention described herein to have the platform 10 available through a variety of mediums. The platform 10 may be accessed through a computer or mobile device. The platform 10 may take the form of downloadable software, a smart phone application, or a web-based application. Any form chosen with sound engineering judgment may be utilized and still be encompassed within the scope of the present invention.

The embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

1. A method of marketing to customers, comprising the steps of:
providing a platform on a global computer network for buying and selling of a good and/or service;
providing a business, said business selectively offering said good and/or service at a first price, wherein said good and/or service are available for sale outside of said platform at a second price, wherein said first price is less than said second price;
providing an account with said platform to a customer, said customer paying a subscription fee during a repeating time period;
offering said customer said good and/or service at said first price;
sending said customer a voucher; and
redeeming said voucher with said business, wherein said customer pays said first price when said voucher is redeemed with said business.

2. The method of claim 1, wherein said business does not pay financial consideration to said platform for offering said good and/or service at said first price.

3. The method of claim 1, wherein said customer subscription fee is reduced when said customer refers a second customer to said platform.

4. The method of claim 3, wherein said customer subscription fee is zero when said customer refers a plurality of customers to said platform.

5. The method of claim 1, wherein said customer subscription fee is reduced when said customer refers a second customer to said platform and said second customer pays its own subscription fee.

6. The method of claim 1, wherein said business is a generic business type.

7. The method of claim 1, wherein said business is a specific business having an operating address.

8. The method of claim 1, wherein said step of offering said customer said good and/or service at said first price is based upon user preferences determined by said customer.

9. The method of claim 1, wherein said platform is a website.

10. The method of claim 1, wherein said business pays financial consideration to said website for offering said good and/or service but does not pay additional financial consideration on a per transaction basis.

11. The method of claim 1, wherein said business does not pay financial consideration to said platform on a per transaction basis.

12. A method of marketing to customers, comprising the steps of:
providing a platform on a global computer network for buying and selling of a good and/or service;
providing a business, said business selectively offering said good and/or service at a first price, wherein said good and/or service are available for sale outside of said platform at a second price, wherein said first price is less than said second price;
providing an account with said platform to a customer, said customer desiring to receive said good and/or service from said business at said first price;
offering said customer a first payment option and a second payment option for purchasing said good and/or service at said first price;
receiving said customer's selection of said first payment option or said second payment option; and
sending said customer a voucher.

13. The method of claim 12, wherein said first payment option further comprises the steps of:
paying a subscription fee during a repeating time period;
redeeming said voucher via said business; and
paying for said good and/or service at said first price.

14. The method of claim 13, wherein said business does not pay financial consideration to said platform for offering said good and/or service at said first price.

15. The method of claim 12, wherein said second payment option further comprises the step of:
paying for said good and/or service at said first price via said platform before receiving said voucher.

16. The method of claim 15, wherein said business pays financial consideration to said platform for offering said good and/or service at said first price.

17. The method of claim 12, wherein said option of when to purchase said good and/or service at said first price requires a subscription.

18. The method of claim 12, wherein said business offering vouchers through said second option do not offer vouchers with said first option.

19. The method of claim 12, wherein voucher received by said customer is based upon said customer's preferences as specified in its account.

20. A method for marketing to both customers and businesses, comprising the steps of:
providing a platform on a global computer network for buying and selling of a good and/or service;
providing a business, said business selectively offering said good and/or service at a first price, wherein said good and/or service are available for sale outside of said platform at a second price, wherein said first price is less than said second price;
providing a customer having an account with said platform, said customer desiring to receive said good and/or service from said business at said first price;
providing said customer an option of when to purchase said good and/or service at said first price wherein said option requires a subscription;
receiving a voucher for said good and/or service from said platform at said first price;
redeeming said voucher for said good and/or service wherein said purchase occurs through said platform or said business;
allowing said business or said customer to refer a new client; and
providing commission to said business or said customer for said buying and selling by said new client, wherein said commission is provided to at least one of said business and said customer for referring said another client.
